(19) United States
(12) Patent Application Publication
(10) Pub. No.: US 2011/0283044 A1
(43) Pub. Date: Nov. 17, 2011

(54) DEVICE AND METHOD FOR RELIABLE DATA STORAGE

(75) Inventors: Edwin S. Olds, Fort Collins, CO (US); Timothy R. Feldman, Louisville, CO (US); Joshua B. Tinker, Fort Collins, CO (US); Lace J. Herman, Firestone, CO (US)

(73) Assignee: SEAGATE TECHNOLOGY LLC, Scotts Valley, CA (US)

(21) Appl. No.: 12/777,466

(22) Filed: May 11, 2010

(51) Int. Cl. G06F 12/00; G06F 12/02; G06F 12/06

(52) U.S. Cl. 711/102; 711/111; 711/170; 711/E12.001; 711/E12.002; 711/E12.084

(57) ABSTRACT

A data storage device comprising at least one non-volatile storage medium having a plurality of data blocks, and a controller configured to allocate at least one of the data blocks for a writing operation based at least in part on data integrities of the data blocks.

### BACKGROUND

The present disclosure is directed to data storage devices. In particular, the present disclosure is directed to devices and techniques for storing data with increased storage reliability.

Disk storage devices, such as magnetic disk drives and solid state drives, are used to store data for subsequent retrieval. While such devices exhibit good operational lives, over extended periods of use, various components of the devices may be prone to potential damage or failure (e.g., head disk assembly failure). After component damage or drive failures, the data stored on the devices may be irretrievably lost. Thus, there is an ongoing need for systems and techniques for providing reliable data storage.

### SUMMARY

An aspect of the present disclosure is directed to a data storage device that includes at least one non-volatile data storage medium having a plurality of data blocks, and a controller. The controller is configured to allocate at least one data block of the plurality of data blocks for a writing operation based at least in part on data integrities of the plurality of data blocks.

Another aspect of the present disclosure is directed to a data storage device that includes at least one non-volatile storage medium and a controller. The at least one non-volatile storage medium includes a plurality of data blocks, where a first portion of the data blocks have higher data integrities compared to a second portion of the data blocks. The controller is configured to write a designated data file to at least one data block of the first portion and to write a non-designated data file to at least one data block of the second portion.

Another aspect of the present disclosure is directed to a data storage device that includes at least one primary storage medium and at least one non-volatile memory having a plurality of data blocks. The data storage device also includes a controller configured to allocate a first portion of the plurality of data blocks to function as a non-data cache storage location, and to allocate a second portion of the plurality of data blocks to function as a data cache for the at least one primary storage medium.

### BRIEF DESCRIPTION OF THE DRAWINGS

FIG. 1 is a schematic illustration of a data storage device of a first embodiment of the present disclosure in use with a host computer, where the data storage device is a hybrid device that includes a non-volatile memory and a head disk assembly.

FIG. 2 is a schematic illustration of a data storage device of a second embodiment of the present disclosure, where the data storage device is a hybrid device that includes non-volatile memory and solid state memory.

FIG. 3 is a schematic illustration of a data storage device of a third embodiment of the present disclosure, where the data storage device includes solid state memory.

FIG. 4 is a schematic illustration of a data storage device of a fourth embodiment of the present disclosure, where the data storage device includes a head disk assembly.

FIG. 5 is a flow diagram of a method of operating a data storage device of the present disclosure.

FIG. 6 is a flow diagram of an alternative method of operating a data storage device of the present disclosure.

### DETAILED DESCRIPTION

The present disclosure is directed to data storage devices for writing designated data to data blocks having high data integrities. As used herein, the term “data block” refers to a physical block or track of a storage medium for retaining data, and encompasses physical data blocks of solid state memory, data tracks of magnetic disk media, and the like.

Reliable data storage is generally based on (1) data redundancy and (2) data integrity. Data redundancy may be achieved by backing up the desired data from a primary data storage device to one or more additional storage media, such as with optical media and/or Redundant Array of Independent Disks (RAID) arrangements. However, many users are not accustomed to backing up their data on a frequent basis, and increased numbers of storage media may reduce the security of confidential and sensitive data. Thus, to reduce the risk of losing critical data, such as important documents and personal photograph images, the data storage devices of the present disclosure allow users to reliably store designated data in data blocks having high data integrities.

As used herein, the term “data integrity” refers to the reliability of storing and subsequently retrieving data from a given data block. Thus, data blocks having high data integrities are capable of storing data in manners such that the data can be retrieved over extended periods of time, and with low risks of data loss. The term “data integrity” is distinguishable from “data redundancy,” which is based on the use of mirroring and/or parity data stored on multiple storage media, and which is generally independent of the data integrities of the given data blocks. Accordingly, data integrity is dependent on the type of data storage device used, and as discussed below, may be based on a variety of factors, such as the risk of mechanical or electrical failure of a data block and/or reading mechanism, the risk of accidental erasure of the data block, the risk of physical, electrical, or chemical damage to the data block and/or reading mechanism, and the like.

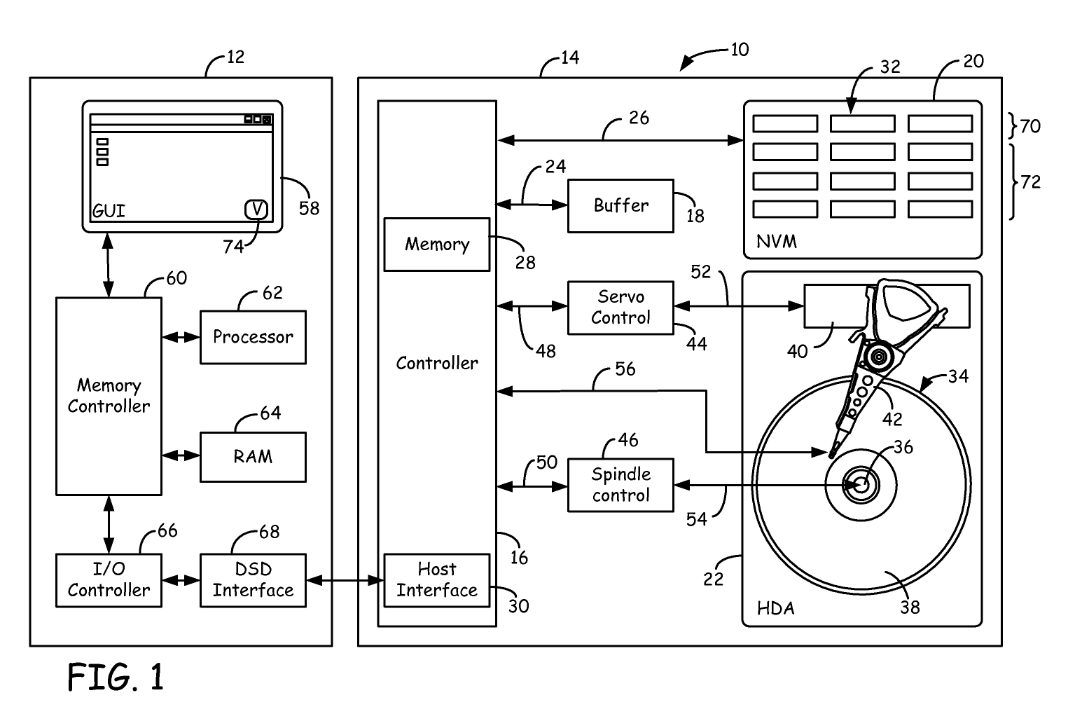

FIG. 1 shows storage device 10 in use with host computer 12, where host computer 12 may be one or more computer-based systems configured to engage with storage device 10. Storage device 10 is an example of a suitable data storage device of the present disclosure, and includes housing 14, controller 16, buffer 18, non-volatile memory (NVM) 20, and head disk assembly (HDA) 22. Housing 14 is an exterior casing for storage device 10, which desirably encases and protects the interior components, such as one or more of controller 16, buffer 18, NVM 20, and HDA 22. Accordingly, storage device 10 may be internal or external to a casing of host computer 12.

Controller 16 is a circuit assembly that directs the reading and writing operations for storage device 10, and is configured to respectively communicate with buffer 18 and NVM 20 over control connection 24 and 26. Controller 16 also includes memory module 28, which may be any suitable type of non-volatile memory for storing information such as firmware. Controller 16 communicates with host computer 12 via host interface 30, where host interface 30 may be any suitable interface, such as a universal serial bus (USB) interface, a Serial Advanced Technology Attachment (SATA) interface, an External SATA (eSATA) interface, a Parallel Advanced Technology Attachment (PATA) interface, an IEEE 1394 interface, a Small Computer System Interface (SCSI), a Serial Attached SCSI (SAS) interface, an Integrated Drive Electronics (IDE) interface, a Fiber Channel interface, and the like.

buffer 18 is one or more volatile memory modules (e.g., dynamic random access memory) that may function as a data cache during reading and/or writing operations with HDA 22. NVM 20 is one or more solid state, non-volatile memory, such as flash memory, magnetic random access memory (MRAM), electrically erasable programmable read-only memory (EEPROM), ferroelectric random access memory (FeRAM), and combinations thereof. NVM 20 includes a plurality of erasable data blocks (referred to as data blocks 32) for storing data, and may function as a non-volatile data cache during reading and/or writing operations with HDA 22.

HDA 22 is one or more head disk assemblies, and is the primary storage medium/media for storage device 10. HDA 22 includes storage disk 34 and spindle motor 36, where spindle motor 36 rotates storage disk 34 in a rotational direction during operation. Storage disk 34 includes recordable surface 38, which is a surface of storage disk 34 having multiple concentric data tracks (not shown) for storing data. HDA 22 further includes actuation motor 40 (e.g., a voice coil motor) and actuator arm assembly 42, where actuator arm assembly 42 may include an actuator arm, suspension assembly, and slider to carry a transducing head for writing data to, and reading data from, the data tracks in recordable surface 38. Actuation motor 40 is configured to pivot actuator arm assembly 42 about an axis to sweep the transducing head in an arc over recordable surface 38.

The operation of HDA 22 is directed by controller 16, where controller 16 respectively communicates with servo control 44 and spindle control 46 over control connections 48 and 50. Servo control 44 communicates with actuation motor 40 over connection 52, thereby directing actuation motor 40 to move actuator arm assembly 42 to desired locations over across recordable surface 38, based on commands from controller 16. Correspondingly, spindle control 46 communicates with spindle motor 36 over connection 54, thereby directing spindle motor 36 to rotate storage disk 34 based on commands from controller 16. Controller 16 communicates with the transducing head of actuator arm assembly 42 over control connection 56, which allows data to be written to, and read from, the data tracks on recordable surface 38 in a conventional manner. Control connection 56 may also include one or more additional components that assist in the reading and/or writing operations, such as read/write channels for encoding and reconstructing data, preamplifiers, driver circuits, and the like.

As discussed above, host computer 12 may be one or more computer-based systems configured to engage with storage device 10. Examples of suitable systems for host computer 12 include desktop computers, laptops, server-based systems, personal digital assistants (PDA), telecommunication devices, multimedia players (e.g., portable multimedia players), and combinations thereof. In the embodiment shown in FIG. 1, host computer 12 includes graphical user interface (GUI) 58, memory controller 60, processor 62, RAM 64, input/output (I/O) controller 66, and data storage device (DSD) interface 68. Host computer 12 may also include a variety of additional components that are typically contained in computer-based systems.

GUI 58 is a user interface, such as an operating system interface, that may be instantiated and stored in RAM 64 during operation. Memory controller 60 is a circuit assembly that interfaces the components of host computer 12 with RAM 64, and may include logic for mapping addresses of the components of host computer 12 to particular areas of RAM 64. Processor 62 is one or more processing units, and RAM 64 is one or more volatile random access memory modules. I/O controller 66 is a circuit assembly that interfaces memory controller 60, processor 62, and RAM 64 with various input and output components of host computer 12, including DSD interface 68. DSD interface 68 is the reciprocating interface of host interface 30, which allows storage device 10 to engage and communicate with host computer 12. Suitable interfaces for DSD interface 68 include the reciprocating interfaces for those discussed above for host interface 30. Furthermore, I/O controller 66 and/or the DSD interface 68 may include logic to support RAID technology, thereby allowing storage device 10 to operate using RAID technology.

Prior to use, controller 16 may identify one or more data blocks 32 of NVM 20 and/or data tracks of HDA 22 as having high data integrities. This may be accomplished with firmware stored on a computer storage medium (e.g., memory module 28), where the firmware may include criteria for determining the data integrities of data blocks 32 and the data tracks of HDA 22. The identification may be based on predetermined criteria (i.e., a predetermined identification) and/or criteria that may dynamically change based on operational characteristics of storage device 10 (i.e., an active identification). For storage device 10, which is a hybrid data storage device, examples of suitable criteria for determining data integrities include the risks of mechanical or electrical failures in data blocks 32 and the data tracks of HDA 22, the risks of electronic failures in one or more connections between controller 16 and NVM 20/HDA 22, the risks of mechanical or electrical failures in actuator arm assembly 42, the risks of physical, electrical, or chemical damage to data blocks 32 and the data tracks of HDA 22, the risks of reading/writing errors in NVM 20 or HDA 22, the risks of accidental erasures of data blocks 32 and the data tracks of HDA 22, and combinations thereof.

In one embodiment, the criteria for determining data integrities may be based on a comparison of data blocks between multiple storage media, such as between data blocks 32 of NVM 20 and the data tracks of HDA 22. Over extended periods of operation, magnetic disk storage systems, such as HDA 22, may undergo mechanical or electronic failures. This can lead to the loss of data stored on such devices, where the given data may be irreplaceable. In comparison, however, solid state memory, such as data blocks 32 of NVM 20, do not contain moving parts and are less likely to experience electronic failures. Thus, pursuant to the criteria, controller 16 may identify data blocks 32 as having greater data integrities compared to the data tracks of HDA 22.

Additionally or alternatively, the criteria for determining data integrities may be based on a comparison of data blocks within a single storage medium, such as between the particular data blocks 32 of NVM 20. Variations in data integrities between the particular data blocks 32 may be due to a variety of factors, such as physical locations, available erasure counts, reading and/or writing variations, accessibility, and the like. For example, a first region of data blocks 32 (referred to as data blocks 70) may be more readily accessible to electrical connections compared to the remaining data blocks 32 (referred to as data blocks 72). In the event of an electronic failure, data blocks 70 may be accessed more readily than the remaining data blocks 72, thereby allowing the data retained in data blocks 70 to be retrieved. Alternatively, data blocks 70 may have lower erasure counts compared to the remaining data blocks 72. Data blocks in many types of non-volatile media (e.g., flash memory) have limited numbers of available erasures before the given data blocks fail. As such, data blocks having lower erasure counts may have greater data integrities compared to data blocks having higher erasure counts.

In the current example, pursuant to the criteria, controller 16 may identify data blocks 70 as having the highest data integrities for storage device 10. Thus, controller 16 desirably allocates data blocks 70 to function as a storage location for designated data. However, as discussed above, NVM 20 functions as a temporary data cache for HDA 22. Under a conventional operation, data stored in data blocks 32 (including data blocks 70) is typically erased after being copied to HDA 22. Thus, to prevent the designated data from being erased from data blocks 70, controller 16 may allocate one or more of data blocks 70 to function as a non-data cache storage location. The allocation may be made with logical block address mapping, and desirably allows data blocks 72 to remain functioning as a temporary data cache for HDA 22. This arrangement effectively removes data blocks 70 from data caching during conventional write operations to HDA 22.

Data blocks 70 may be located in a single region of NVM 20, or alternatively, may be distributed throughout NVM 20. Additionally, in one embodiment, data blocks 70 may encompass a fixed volume of data blocks 32. Examples of suitable fixed volumes include about 50% or less of data blocks 32, with particularly suitable fixed volumes including about 25% or less of data blocks 32, and with even more with particularly suitable fixed volumes including about 15% or less of data blocks 32. The suitable ranges may also vary depending on the overall volume of NVM 20, and desirably provide a suitable balance between storage volume and data cache volume for NVM 20. In an alternative embodiment, particular data blocks 70 may be allocated to function as a non-data cache storage location on an ongoing basis. Thus, when a user saves designated data to storage device 10, controller 16 allocates a suitable number of data blocks 32 to function as data blocks 70. This increases the volume of data blocks 70 and decreases the volume of data blocks 72 on an as-needed basis. Correspondingly, when the user deletes designated data from data blocks 70, controller 16 may then remove the allocation to free the given data blocks 70 up to function as data blocks 72.

Write operations to storage device 10 may vary depending on whether a given data file is designated to be stored in data blocks 70 (e.g., by a user with host computer 12). When a user of host computer 12 saves a data file in a non-designated manner, the data file may be written to storage device 10 in a conventional manner. For example, when saving a non-designated data file with GUI 58, a software routine may relay the data file to controller 16 via DSD interface 68 and host interface 30 as designated data. The data may then be stored in buffer 18 and/or data blocks 72 of NVM 20, which allows the data to be temporarily stored until storage disk 34 is spun up. At that point in time, controller 16 may then move the data from buffer 18 and/or data blocks 72 to the transducing head of actuator arm assembly 42, which correspondingly writes the data to the data tracks in recordable surface 38. In an alternative embodiment, buffer 18 may be omitted and the data may be temporarily written to data blocks 72 of NVM 20 prior to writing the data to HDA 22.

In comparison, a designated data file is desirably written to data blocks 70 having high data integrities, and which are desirably inaccessible to non-designated data files. For example, GUI 58 may include a graphical icon, such as vault icon 74, which may be instantiated with GUI 58 and stored in RAM 64 during use. The user operating host computer 12 via GUI 58 may select a data file that the user desires to have stored in a reliable manner (e.g., important documents and personal photograph images), and drag the data file to vault icon 74. When the data file is dropped in vault icon 74, a software routine may relay the data file to controller 16 via DSD interface 68 and host interface 30 as designated data. Based on the logical block address mapping, controller 16 may then store the designated data file in data blocks 70 having high data integrities.

In the event that data blocks 70 are full, host computer 12 may present a dialog box (not shown) in GUI 58 to the user indicating that no remaining space is available. The user may then delete one or more data files currently stored within data blocks 70 to provide available data tracks, or decline to save any further data in this manner. Furthermore, in one embodiment, the firmware stored in memory module 28 may also include routines that prevent static wear leveling of erasure counts within data blocks 70. Thus, in this embodiment, data blocks 70 are not subjected to a static wear leveling process, while data blocks 72 may remain subjected to the static wear leveling. This reduces the risk of losing the stored data for the purpose of maintaining relatively uniform erasure counts between data blocks 32.

Furthermore, in one embodiment, controller 16 may write designated data files to one or more data blocks 70 and to one or more data blocks 72. The data files written to data blocks 72 may then be written to the data tracks of HDA 22, as discussed above. This effectively creates a backup copy of the desired data files within data blocks 70, thereby creating data redundancy to further reduce the risk of losing the data files in the event of a failure of HDA 22. This redundancy is also attained without requiring the data files to be distributed among multiple storage media (e.g., optical disks), which may be undesirable for confidential and sensitive data. This embodiment is also beneficial for use with encryption protocols in storage device 10, which further increase the security protection of the data files.

Selecting data blocks having high data integrities (e.g., data blocks 70) for writing operations increases the likelihood of retrieving the written data at a subsequent point in time. This allows designated data, such as important documents and personal photograph images designated by a user, to be reliably stored on the storage media without requiring redundant copies of the data to be made. As discussed above, this is particularly beneficial for users who are not accustomed to backing up data on a frequent basis. Furthermore, with respect to hybrid drives such as storage device 10, this arrangement allows NVMs (e.g., NVM 20) to function as a non-data cache storage location for designated data and as a temporary cache for the respective HDA (e.g., HDA 22), thereby increasing the versatility of the storage device.

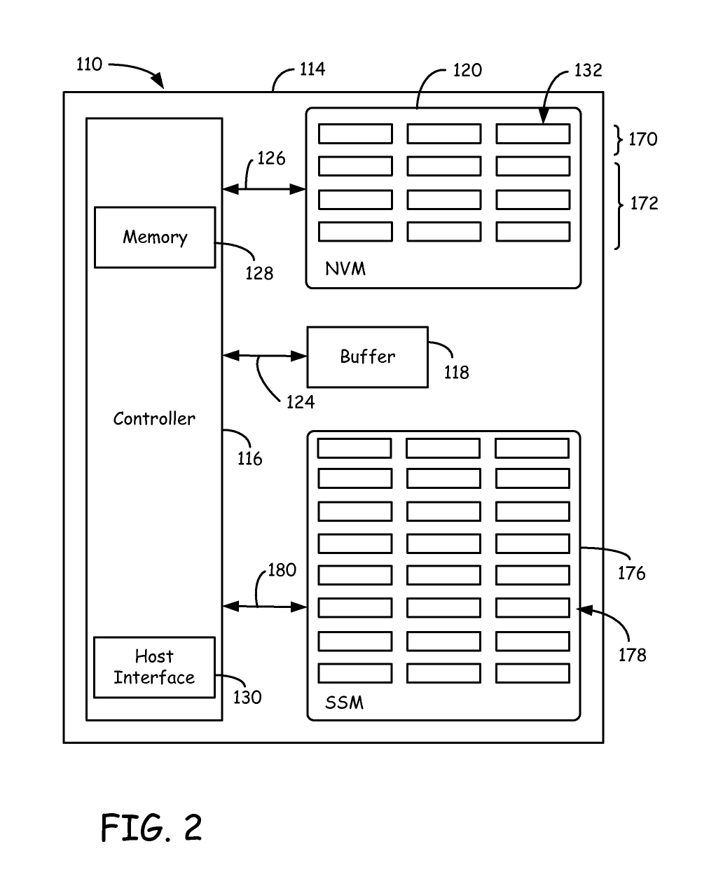

FIGS. 2-4 illustrate alternatives to storage device 10 (shown in FIG. 1) for use with host computer 12 (shown in FIG. 1), where the reference labels are respectively increased by 100, 200, and 300. As shown in FIG. 2, storage device 110 includes solid state memory (SSM) module 176 in lieu of HDA 22 (shown in FIG. 1). SSM module 176 is one or more solid state, non-volatile memory, and is the primary storage medium/media for storage device 110. Examples of suitable memory for SSM module 176 include flash memory, magnetic random access memory (MRAM), electrically erasable programmable read-only memory (EEPROM), ferroelectric random access memory (FeRAM), and combinations thereof. SSM module 176 includes a plurality of erasable data blocks (referred to as data blocks 178) for storing data, and controller 116 communicates with SSM 176 over control connection 180.

As discussed above for storage device 10, prior to use, controller 116 desirably identifies one or more data blocks 132 of NVM 120 and/or data blocks 178 of SSM 176 as having high data integrities. This may also be accomplished with firmware stored on a computer storage medium (e.g., memory module 128), where the firmware may include criteria for determining the data integrities of data blocks 132 and 178. For storage device 110, which is also a hybrid data storage device, examples of suitable criteria for determining data integrities include the risks of electronic failures in one or more connections between controller 16 and NVM 120/SSM module 176, the risks of physical, electrical, or chemical damage to data blocks 132 and 178, the risks of reading/writing errors in NVM 120 or SSM module 176, the risks of accidental erasures of data blocks 132 and 178, and combinations thereof.

In one embodiment, the criteria for determining data integrities may be based on a comparison of data blocks between multiple storage medium and/or a comparison of data blocks within a single storage medium, as discussed above. For example, NVM 120 may be manufactured from higher-quality and higher-cost materials compared to SSM module 176, which is suitable for NVM 120 to function as a high-speed, temporary data cache for SSM module 176. In this situation, data blocks 132 are less likely to experience an electronic failure compared to data blocks 178. As such, pursuant to the criteria, controller 116 may identify data blocks 132 as having greater data integrities compared to data blocks 176.

Furthermore, the particular data blocks 132 within NVM 120 may also have different levels of data integrities, as discussed above for data blocks 32 (shown in FIG. 1), thereby providing data blocks 170 and 172. In the current example for storage device 110, pursuant to the criteria, controller 116 may identify data blocks 170 as having the highest data integrities for storage device 110. Thus, controller 116 desirably allocates data blocks 170 to function as a non-data cache storage location for designated data, while also allowing data blocks 172 to remain functioning as a temporary data cache for SSM module 176. This effectively removes data blocks 170 from data caching during conventional write operations to SSM module 176.

Write operations to storage device 110 may then be performed in substantially the same manner as discussed above for storage device 10. This allows designated data to be reliably stored on the storage media without requiring redundant copies of the data to be made. This also allows NVM 120 to function as a non-data cache storage location for designated data and as a temporary cache for SSM module 176.

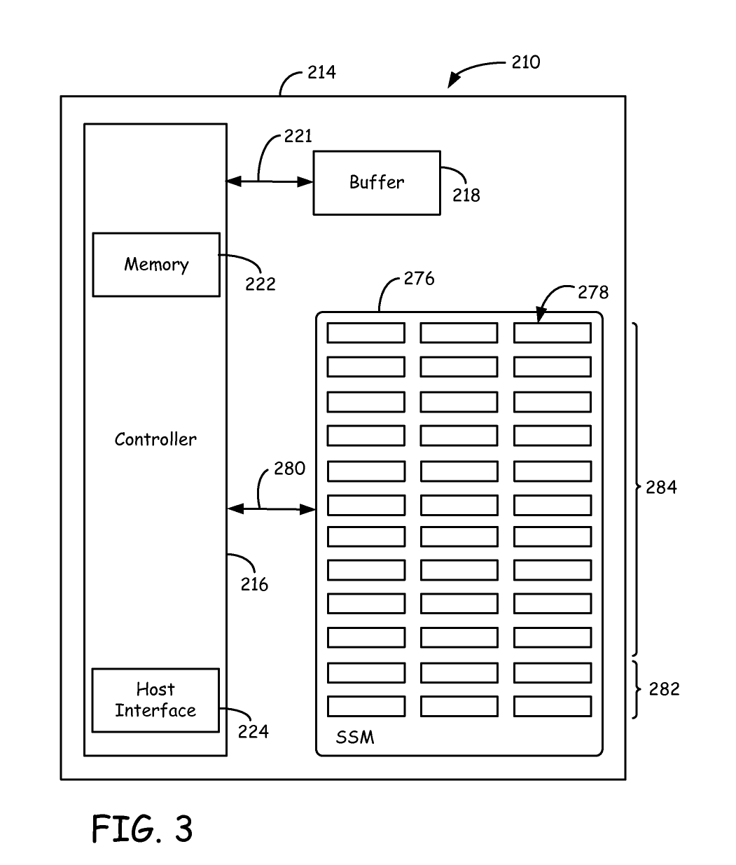

As shown in FIG. 3, storage device 210 is a solid state drive that includes SSM module 276 without an NVM, where SSM module 276 may function in the same manner as SSM module 176 (shown in FIG. 2). In this embodiment, prior to use, controller 216 desirably identifies one or more data blocks 278 of SSM module 276 as having high data integrities. This may also be accomplished with firmware stored on a computer storage medium (e.g., memory module 228), where the firmware may include criteria for determining the data integrities of data blocks 278. Examples of suitable criteria for determining data integrities include the risks of physical, electrical, or chemical damage to the particular data blocks 278, the risks of reading/writing errors in the particular data blocks 278, the risks of accidental erasures of the particular data blocks 278, accessibility of the particular data blocks 278, and combinations thereof.

In one embodiment, a first region of data blocks 278 (referred to as data blocks 282) may be more readily accessible to electrical connections compared to the remaining data blocks 278 (referred to as data blocks 284). In the event of an electronic failure, data blocks 282 may be accessed more readily than the remaining data blocks 284, thereby allowing the data retained in data blocks 282 to be retrieved. Alternatively, data blocks 282 may have lower erasure counts compared to the remaining data blocks 284, as discussed above. As such, pursuant to the criteria, controller 216 may identify data blocks 282 as having greater data integrities compared to data blocks 284. Thus, controller 216 desirably allocates data blocks 282 to store the designated data, and allows data blocks 284 to store the non-designated data.

Data blocks 282 may be located in a single region of SSM module 276, or alternatively, may be distributed throughout SSM module 276. Additionally, in one embodiment, data blocks 282 may encompass a fixed volume of data blocks 278, as discussed above for data blocks 32. Accordingly, examples of suitable fixed volumes include about 15% or less of data blocks 282, with particularly suitable fixed volumes including about 10% or less of data blocks 278, and with even more with particularly suitable fixed volumes including about 5% or less of data blocks 278. The suitable ranges may also vary depending on the overall volume of SSM module 276.

Write operations to storage device 210 may vary depending on whether a given data file is designated to be stored in data blocks 282. When a user saves a non-designated data file, the data file may be written to one or more data blocks 284 in a conventional manner. However, when the user saves a designated data file, the data file is written to one or more data blocks 282 having greater data integrities compared to data blocks 284. This allows designated data to be reliably stored in data blocks of SSM module 276 that have the highest data integrities.

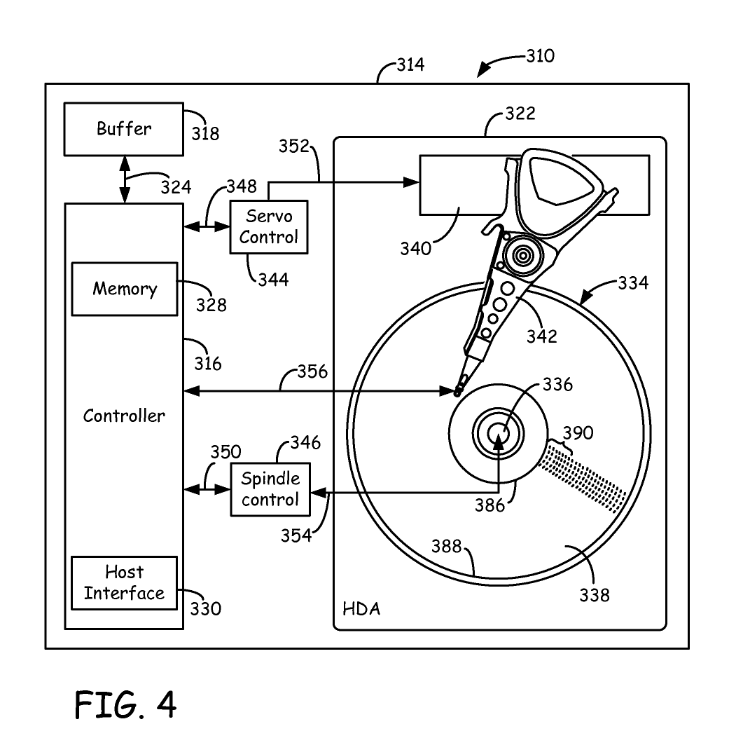

As shown in FIG. 4, storage device 310 is a magnetic disk drive that includes HDA 222 without an NVM, where HDA 222 may function in the same manner as HDA 22 (shown in FIG. 1). In this embodiment, prior to use, controller 316 desirably identifies one or more data tracks in storage disk 334 as having high data integrities. This may also be accomplished with firmware stored on a computer storage medium (e.g., memory module 328), where the firmware may include criteria for determining the data integrities of the data tracks.

As shown, recordable surface 338 of storage disk 334 is located between inner diameter (ID) edge 386 and outer diameter (OD) edge 388, where ID edge 386 is the circumferentially innermost edge of recordable surface 338 and OD edge 388 is the circumferentially outermost edge of recordable surface 338. Storage disk 334 may also include small unwritable regions adjacent to ID edge 386 and/or OD edge 388 (e.g., transition and landing zones). Data tracks located adjacent to ID edge 386 (referred to as region 390) may have greater data integrities compared to data tracks located further concentrically outward, particularly compared to the data tracks located adjacent to OD edge 388. Over extended periods of operation, actuator arm assembly 342 may occasionally contact recordable surface 338 at locations adjacent to OD edge 388. Such contacts may potentially damage the data tracks at such locations, which can result in data loss.

These contacts between actuator arm assembly 342 and recordable surface 338 are less likely to occur at locations adjacent to ID edge 386. This reduces the risk of damaging the data tracks within region 390. Thus, the data tracks located in region 390 may have greater data integrities compared to data tracks that are located concentrically further outward, and data stored in region 390 is at less risk of being lost. Examples of suitable ranges for region 390 between ID edge 386 and OD edge 388 include the data tracks that are located within about 25% of the distance from ID edge 386 or less, with particularly suitable ranges including about 15% or less, and with even more particularly suitable ranges including about 10% or less, where the distance from ID edge 386 is based on an entire radial distance between ID edge 386 and OD edge 388.

In the current example, pursuant to the criteria, controller 316 may identify the data tracks within region 190 as having the highest data integrities for storage device 310. Thus, controller 316 desirably allocates the data tracks within region 390 to store the designated data, and allows the data tracks outside of region 390 to store the non-designated data. Write operations to storage device 310 may vary depending on whether a given data file is designated to be stored in the data tracks within region 190. When a user saves a non-designated data file, the data file may be written to one or more data tracks outside of region 390. However, when the user saves a designated data file, the data file is written to one or more tracks within region 290. This allows designated data to be reliably stored in data tracks HDA 322 that have the highest data integrities.

In alternative embodiments, pursuant to the criteria, controller 316 may identify other data tracks of recordable surface 338 as having the highest data integrities for storage device 310. For example, the identification may be based on predetermined data track locations or ranges along recordable surface 338 other than region 390 (e.g., mid-disk locations). In another example, the identification may be based on particular designs of given data tracks, such wide data tracks, which may exhibit high levels of data integrities.

In additional alternative embodiments, storage device 310 may include a plurality of storage disks 334 in a stacked arrangement and a plurality of corresponding transducing heads in an E-block arrangement. In this embodiment, controller 316 may communicate with each transducing head over control connection 356, and may identify data tracks within regions 390 in each storage device 310 having high data integrities. This is beneficial for increasing the overall volume of data tracks having high data integrities.

Additionally, the multiple-disk arrangement is beneficial for reducing the risk of data loss in the event that one or more of the transducing heads experiences an electronic failure and/or one or more of storage disks 334 is damaged (e.g., due to contact with a transducing head). Such events may be identified by a reduction in the reading and writing capabilities of the given transducing head(s). In these situations, the data tracks on the corresponding storage disk(s) 334 may no longer be capable of reliably storing data in a retrievable manner. Controller 316 may then omit these storage disk(s) 334, entirely or in part, from the allocated locations to store designated data files. The designated data files may then be stored in data tracks within regions 390 on other storage disks 334.

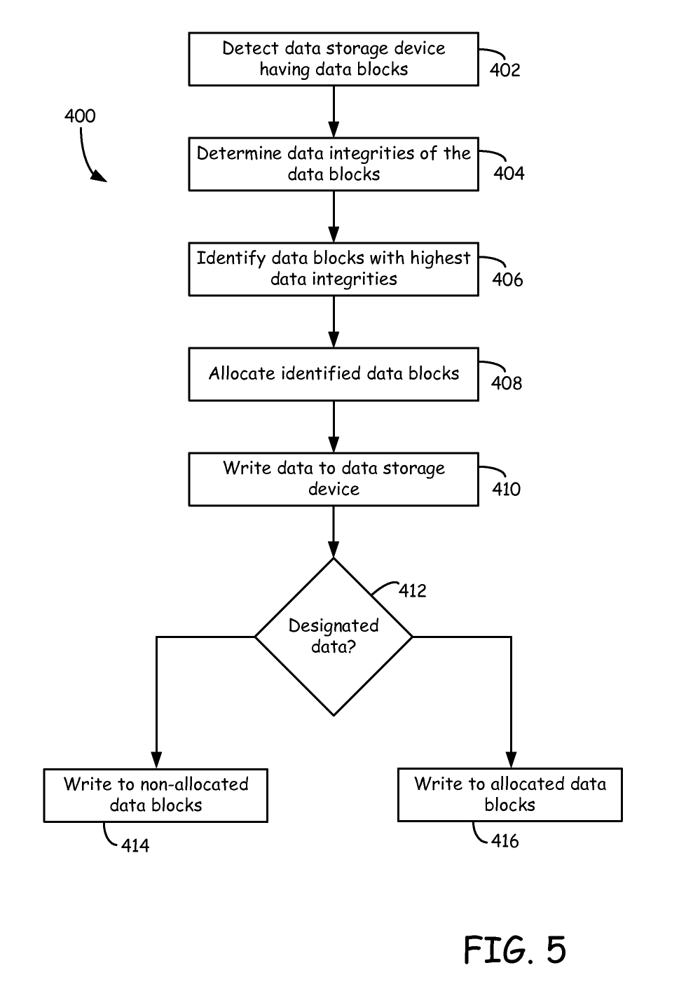

FIG. 5 is a flow diagram of method 400 for operating the data storage devices of the present disclosure (e.g., storage devices 10, 110, 210, and 310). As shown, method 400 includes steps 402-416, and initially involves detecting a data storage device by a host computer, such as storage devices 10, 110, 210, and 310, and host computer 12 (step 402). Method 400 may be performed with a variety of different data storage devices that have data blocks with different levels of data integrities. Examples of suitable data storage devices for use with method 400 include hybrid devices (e.g., storage devices 10 and 110), solid state drives (e.g., storage device 210), magnetic disk drives (e.g., storage device 310), and combinations thereof. The data storage device may be detected by the host computer in a conventional manner, such as through an engagement between a host interface of the data storage device (e.g., host interface 30) and the reciprocating DSD interface of the host computer (e.g., DSD interface 68).

The controller of the data storage device (e.g., controller 16) may then determine the data integrities of the data blocks in the data storage device (step 404). As discussed above, this may be accomplished with firmware that includes criteria for determining the data integrities of the data blocks. For example, the identification may be based on predetermined criteria (i.e., a predetermined identification) and/or criteria that may dynamically change based on operational characteristics of the storage device (i.e., an active identification). Based on the determination, the controller may then identify one or more data blocks having the highest data integrities (step 406). As discussed above, this may be based on a comparison of data blocks between multiple storage media and/or a comparison of data blocks within a single storage medium. For example, pursuant to the criteria, controller 16 of storage device 10 may identify data blocks 70 of NVM 20 as having the highest data integrities compared to data blocks 72 of NVM 20 and the data tracks of HDA 22.

The controller may then allocate the identified data blocks to remain separate from the remaining data blocks of the data storage device (step 408). The data block allocation may be made by mapping the identified data blocks with logical block addresses that logically separate the identified data blocks from the remaining data blocks of the storage device. Data may then be written to the data blocks of the data storage device (step 410), where the given write operation may vary depending on whether a given data file is designated to be stored in the allocated data blocks (step 412). For example, a user operating a host computer (e.g., host computer 12) may save a data file in a conventional manner. In this situation, the data file is a non-designated data file, and the controller of the data storage device writes the given data file to one or more non-allocated data blocks (e.g., data blocks 72 and/or the data tracks of HDA 22) (step 414).

Alternatively, if the user desires to save a particular data file in data blocks having high data integrities, the user may save the data file in a manner that identifies the data file as a designated data file. The controller then writes the designated data file to one or more allocated data blocks (e.g., data blocks 70) (step 416). Steps 410-416 may then be repeated to allow a user to write non-designated data files to the non-allocated data blocks, while also allowing the user to reliably store designated data files in the allocated data blocks having high data integrities. This allows designated data, such as important documents and personal photograph images, to be reliably stored on the storage media without requiring redundant copies of the data to be made.

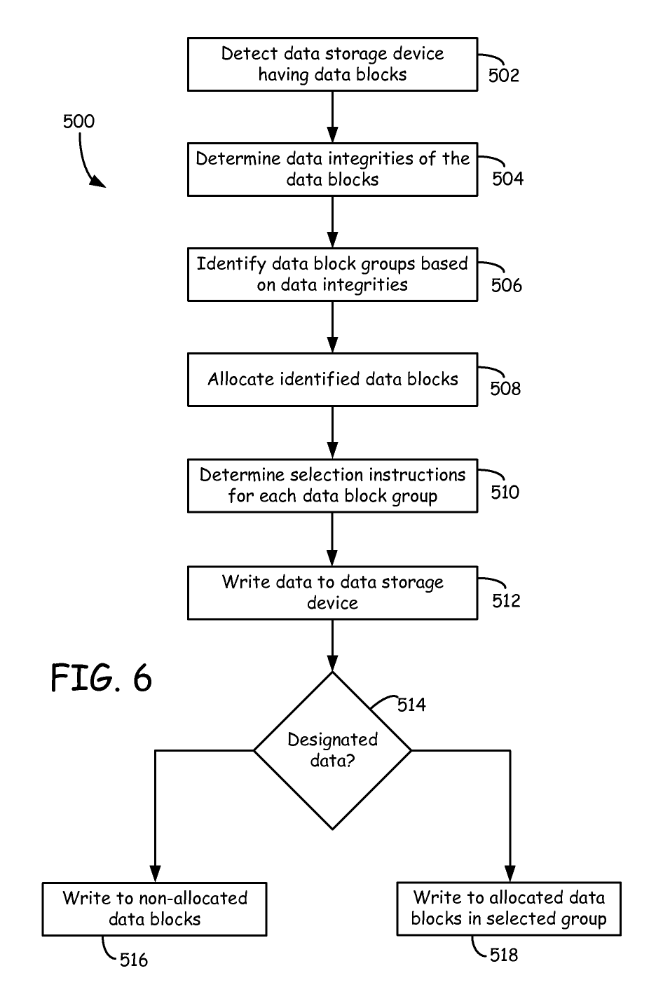

FIG. 6 is a flow diagram of method 500 for operating the data storage devices of the present disclosure (e.g., storage devices 10, 110, 210, and 310), which is an alternative to method 400 (shown in FIG. 5). In the embodiment of method 500, the data blocks may be grouped into multiple tiered levels of data integrities, rather than merely identifying a single group of data blocks having the highest data integrities. As shown, method 500 includes steps 502-518, and initially involves detecting a data storage device by a host computer, such as storage devices 10, 110, 210, and 310, and host computer 12 (step 502). Method 500 may also be performed with a variety of different data storage devices that have data blocks with different levels of data integrities. Examples of suitable data storage devices for use with method 500 include those discussed above for method 500. The data storage device may be detected by the host computer in a conventional manner, such as through an engagement between a host interface of the data storage device (e.g., host interface 30) and the reciprocating DSD interface of the host computer (e.g., DSD interface 68).

The controller of the data storage device (e.g., controller 16) may then determine the data integrities of the data blocks in the data storage device in the same manner as discussed above for step 404 of method 500 (step 504). Based on the determination, the controller may identify groups of one or more data blocks based on the data integrities of the data blocks (step 506). As discussed above, this may be based on a comparison of data blocks between multiple storage media and/or a comparison of data blocks within a single storage medium. For example, controller 16 of storage device 10 may identify data blocks 72 of NVM 20 as having higher data integrities compared to the data tracks of HDA 22, and may also identify data blocks 70 of NVM 20 as having higher (e.g., the highest) data integrities compared to either data blocks data blocks 72 of NVM 20 and the data tracks of HDA 22. This arrangement provides two groups of data blocks identified as having high data integrities. The first group contains data blocks (e.g., data blocks 70) identified as having the highest data integrities. The second group contains data blocks (e.g., data blocks 72) identified as having data integrities that are higher than those of the remaining data blocks of the data storage device (e.g., the data tracks of HDA 22), but are lower than the data integrities of the first group data blocks.

The controller may then allocate the data blocks of each identified group to remain separate from each other and (step 508). The data block allocation may be made by mapping the identified data blocks with logical block addresses that logically separate the data blocks identified in each group from the data blocks of other groups. Selection instructions may also be determined for each data block group (step 510), which provides instructions for which group of identified data blocks should be selected for receiving the designated data. The selection instructions may be determined in a variety of manners, and may be performed manually by a user of the host computer (e.g., through GUI 58) and/or in an automated manner by the host computer or the controller of the storage device. For example, the selection instructions may indicate that designated data having a first particular file format (e.g., a word processing document) is to be written to data blocks in the group having the highest data integrities, that designated data having a second particular file format (e.g., an image file) is to be written to data blocks in the group that is one tier below the group having the highest data integrities, and the like. Alternatively, the user of the host computer may use a graphical menu (e.g., through GUI 58) to select which group to save particular data files.

After the selection instructions are determined, data may then be written to the data blocks of the data storage device (step 512), where the given write operation may vary depending on whether a given data file is designated to be stored in the allocated data blocks (step 514). For example, a user operating a host computer (e.g., host computer 12) may save a data file in a conventional manner. In this situation, the data file is a non-designated data file, and the controller of the data storage device writes the given data file to one or more non-allocated data blocks (e.g., data blocks 72 and/or the data tracks of HDA 22) (step 516).

Alternatively, if the user desires to save a particular data file in data blocks having high data integrities, the user may save the data file in a manner that identifies the data file as a designated data file. The controller then writes the designated data file to one or more allocated data blocks of the appropriate group (e.g., data blocks 70 or 72) based on the determined selection instructions (step 518). Steps 512-518 may then be repeated to allow a user to write non-designated data files to the non-allocated data blocks, while also allowing the user to reliably store designated data files in the allocated data blocks having different levels of data integrities. This also allows designated data, such as important documents and personal photograph images, to be reliably stored on the storage media without requiring redundant copies of the data to be made, while also increasing the versatility how the data files may be stored.

Although the present invention has been described with reference to preferred embodiments, workers skilled in the art will recognize that changes may be made in form and detail without departing from the spirit and scope of the invention.

1. A data storage device comprising:
at least one non-volatile storage medium having a plurality of data blocks; and
a controller configured to allocate at least one data block of the plurality of data blocks for a writing operation based at least in part on data integrities of the plurality of data blocks.

2. The data storage device of claim 1, wherein the at least one non-volatile storage medium is selected from the group consisting of at least one magnetic disk, at least one solid state memory, and combinations thereof.

3. The data storage device of claim 1, and further comprising firmware stored on a computer storage medium and comprising criteria for determining the data integrities of the plurality of data blocks.

4. The data storage device of claim 3, wherein the at least one non-volatile storage medium comprises a plurality of storage media, and wherein the criteria of the firmware comprises a comparison of the plurality of data blocks located on separate storage media of the plurality of storage media.

5. The data storage device of claim 3, wherein the criteria comprises a comparison of the plurality of data blocks located a single storage medium of the at least one non-volatile storage medium.

6. The data storage device of claim 1, wherein the at least one non-volatile storage medium comprises:
at least primary storage medium; and
at least one non-volatile memory.

7. The data storage device of claim 6, wherein the at least one non-volatile memory comprises:
a first portion of the plurality of data blocks, the first portion being configured to function as a non-data cache storage location; and
a second portion of the plurality of data blocks, the second portion being configured to function as a data cache for the at least one primary storage medium.

8. The data storage device of claim 1, wherein the at least one non-volatile storage medium comprises a magnetic disk having a recordable surface, and wherein the at least one data block is located within a predetermined range of the recordable surface.

9. A data storage device comprising:
at least one non-volatile storage medium comprising a plurality of data blocks, wherein a first portion of the data blocks of the plurality of data blocks have higher data integrities compared to a second portion of the plurality of data blocks; and
a controller configured to write a designated data file to at least one data block of the first portion and to write a non-designated data file to at least one data block of the second portion.

10. The data storage device of claim 9, wherein the at least one non-volatile storage medium is selected from the group consisting of at least one magnetic disk, at least one solid state memory, and combinations thereof.

11. The data storage device of claim 9, and further comprising firmware stored on a computer storage medium and comprising criteria for determining the data integrities of the plurality of data blocks.

12. The data storage device of claim 9, wherein the data blocks of the first portion are not subject to a static wear leveling process.

13. The data storage device of claim 9, wherein the at least one non-volatile storage medium comprises at least one non-volatile memory, and wherein the first portion of the data blocks are located in the at least one non-volatile memory.

14. The data storage device of claim 9, wherein the at least one non-volatile storage medium comprises a magnetic disk having a recordable surface, and wherein the first portion of the data blocks is located within a predetermined range of the recordable surface.

15. A data storage device comprising:
at least one primary storage medium;
at least one non-volatile memory comprising a plurality of data blocks; and
a controller configured to allocate a first portion of the plurality of data blocks to function as a non-data cache storage location, and to allocate a second portion of the plurality of data blocks to function as a data cache for the at least one primary storage medium.

16. The data storage device of claim 15, wherein the data blocks of the first portion have higher data integrities compared to data blocks of the at least one primary storage medium.

17. The data storage device of claim 15, wherein the data blocks of the first portion have higher data integrities compared to data blocks of the second portion.

18. The data storage device of claim 17, wherein the controller is further configured to allocated a third portion of the plurality of data blocks to function as a second non-data cache storage location, wherein the data blocks of the first portion have higher data integrities compared to data blocks of the third portion.

19. The data storage device of claim 15, and further comprising firmware stored on a computer storage medium and comprising criteria for determining data integrities of the plurality of data blocks.

20. The data storage device of claim 15, wherein the data blocks of the first portion are not subject to a static wear leveling process.
